(19) United States
(12) Patent Application Publication
(10) Pub. No.: US 2026/0365774 A1
(43) Pub. Date: Nov. 19, 2026

(54) WATER-RESISTANT POLYURETHANE FOAM

(71) Applicant: Dow Global Technologies LLC, Midland, MI (US)

(72) Inventor: Ali J. El-Khatib, Midland, MI (US)

(21) Appl. No.: 19/153,657

(22) PCT Filed: Feb. 23, 2023
(86) PCT No.: PCT/US2023/063097

§ 371 Date: Aug. 5, 2025

(51) Int. Cl. C08G 18/08; C08G 18/18; C08G 18/48; C08G 18/70; C08G 18/72; C08G 101/00

(52) U.S. Cl. CPC C08G 18/0838; C08G 18/18; C08G 18/4804; C08G 18/708; C08G 18/72; C08G 2101/00; C08G 2110/0066

(57) ABSTRACT

Water-resistant polyurethane foam compositions include the reaction product of: an isocyanate component containing, at a percent by weight (wt %): a polymeric MDI blend at 65 wt % to 85 wt %, a plasticizer at 10 wt % to 35 wt %, and a cell opener at 0.2 wt % to 2 wt %; and an isocyanate-reactive component containing, at a wt %: a copolymer polyol at 20 wt % to 50 wt %, a polyether polyol having a functionality of 3 to 8 at 15 wt % to 60 wt %, a tertiary amine catalyst at 1 wt % to 10 wt %, a polyetheramine crosslinker having a number average molecular weight of 1 kDa or more at 1 wt % to 10 wt %, a foam stabilizer at 1 wt % to 8 wt %, and a blowing agent at 5 wt % to 15 wt %.

### FIELD

The present invention relates to multicomponent polyurethane foam-forming compositions and processes for making water-resistant polyurethane foams.

### BACKGROUND

Polyurethane foams have been used in the auto and other industries for a number of purposes, including various cavity-filling applications. For example, foams are often inserted into hollow vehicle parts to dampen sound and vibration and to seal the parts to prevent infiltration by water and other fluids. These foams are typically formed by combining reactive polyurethane foam-forming components, applying the resulting composition to an assembly part, and allowing the formulation to foam within cavities present in the part. In practice, part cavities are filled by applying foam-forming composition during assembly, which is aided by components that are easily mixed, dispensed and cure rapidly at moderate temperatures.

Polyurethane foams are used to seal and insulate parts that encounter a wide variety of operating conditions, such as environments below the water line of a vehicle. Common below water line cavities are below the seatbelt tracker mechanism and/or the lower sections of the structural pillars. When exposed to water contact during the lifespan of the vehicle, cavities containing hydrophilic foams can retain moisture leading to metal corrosion, biofilm formation, and unpleasant odor.

### SUMMARY

In one aspect, embodiments of the present disclosure are directed to water-resistant polyurethane foam compositions that include the reaction product of: an isocyanate component containing, at a percent by weight (wt %): a polymeric MDI blend at 65 wt % to 85 wt %, a plasticizer at 10 wt % to 35 wt %, and a cell opener at 0.2 wt % to 2 wt %; and an isocyanate-reactive component containing, at a wt %: a copolymer polyol at 20 wt % to 50 wt %, a polyether polyol having a functionality of 3 to 8 at 15 wt % to 60 wt %, a tertiary amine catalyst at 1 wt % to 10 wt %, a polyetheramine crosslinker having a number average molecular weight of 1 kDa or more at 1 wt % to 10 wt %, a foam stabilizer at 1 wt % to 8 wt %, and a blowing agent at 5 wt % to 15 wt %.

In another aspect, embodiments of the present disclosure are directed to methods that include inserting a solid, thermally expandable polyolefin composition into a cavity, and performing a heat-expansion step by heating the thermally expandable polyolefin composition in the cavity to a temperature sufficient to expand the polyolefin composition to form a foam that fills at least a portion of the cavity.

### DETAILED DESCRIPTION

Compositions disclosed herein include water-resistant polyurethane foams, foam-forming compositions, and methods of generating and applying foams. Water-resistant Polyurethane foam-forming compositions may include one or more of polyols, high molecular weight crosslinker, and surfactants that increase foam hydrophobicity and reduce water uptake. Particularly, a combination of high molecular weight crosslinker (i.e., greater than 1 kDa) with specific cell openers is necessary for preparing PU foam with low water absorption and foam stability. At the same time, no phase separation occurs in polyol part.

Polyurethane foam compositions may be water-resistant, minimizing absorption in in applications where humidity and direct water exposure may occur. For example, water-resistant polyurethane foams disclosed herein may be used to fill cavities in structural components (e.g., below the water line in automobile cavities to reduce noise and vibration), which may also prevent water entry and reduce corrosion and mildew growth. Particularly, polyurethane foam-forming compositions may be used to generate water-resistant foams that absorb a percent by weight of water (wt %) of less than 15 wt % or less than 8 wt % when exposed to 100% relative humidity for 10 days.

Polyurethane foam compositions disclosed herein generally include a product obtained from combining a two-component curable composition: an isocyanate component (“A-side”) and an isocyanate-reactive component (“B-side”). During application, the isocyanate component and B-side are mixed, initiating a curing reaction at room temperature, and forming the polyurethane foam composition. Polyurethane foam compositions may also include one or more polyurethane foam fillers in the isocyanate component and/or the B-side to enhance thermal transport properties.

### A.) Isocyanate Component

The isocyanate component may contain one or more isocyanates or polyisocyanates; linear and/or branched plasticizers; and foam stabilizers and/or other surfactants.

Isocyanates may include any of those known in the art for the preparation of polyurethane foams such as difunctional monomers, oligomers, and prepolymers. Isocyanates may include aliphatic, cycloaliphatic, araliphatic and aromatic isocyanates having an isocyanate functionality greater than 2, such as toluene diisocyanates (TDI), diphenylmethane diisocyanates (MDI), including oligomers and polymers thererof, “crude” or polymeric MDI (polymethylene polyphenylene polyisocyanates), variants of MDI containing urethane, allophanate, urea, biuret, carbodiimide, uretonimine, and/or isocyanurate groups. Examples of carbodiimide and/or uretonimine modified polyisocyanates see U.S. Pat. No. 6,765,034, which is incorporated by reference herein in its entirety.

The isocyanate component may also include one or more isocyanate prepolymers resulting from reaction of an isocyanate-reactive compound with a molar excess of a isocyanate-containing compound or polyisocyanate compound under conditions that do not lead to gelation or solidification. Formation of isocyanate prepolymers is known in the art, and may include reacting (1) at least one isocyanate compound and (2) at least one polyol compound. Examples of commercial isocyanates include, but are not limited to, polyisocyanates under the trade names VORANATE™, PAPI™, and ISONATE™, such as VORANATE™ M 220 or PAPI™ 20, all of which are available from Dow Chemical Company.

Isocyanate prepolymers and polyisocyanates may be described by an isocyanate index, defined as the ratio of isocyanate groups to isocyanate-reactive groups (such as OH groups) multiplied by 100. Isocyanate prepolymers disclosed herein may have an isocyanate index range of from 60 to 300, 75 to 300, or 100 to 200. Isocyanate value (NCO value) as determined by ASTM D5155-19 for the isocyanates may be 10% or greater, 15% or greater, or 18% or greater. Isocyanates may have an average isocyanate equivalent weight of from 80 g/eq to 400 g/eq, such as from a lower limit of 80 g/eq, 90 g/eq, or 100 g/eq to an upper limit of 400 g/eq, 390 g/eq, or 380 g/eq.

The isocyanate component may include one or more isocyanates at a percent by weight (wt %) of 50 wt % or more, such as 50 wt % to 95 wt %, 60 wt % to 90 wt %, or 65 wt % to 85 wt %.

The isocyanate component may include one or more plasticizers, including one or more branched and/or linear plasticizers. In some cases, the one or more plasticizers may include a blend of linear and branched plasticizers, where the linear plasticizer is present as a percent by weight of the total plasticizer of 25 wt % or more, 30 wt % or more, or 45 wt % or more.

Suitable plasticizers are various carboxylic ester compounds such as bis(2-ethylhexyl) phthalate, diisononyl phthalate, bis(n-butyl) phthalate, butyl benzyl phthalate, diisodecyl phthalate, diethyl phthalate, diisobutyl phthalate, di-n-hexyl phthalate, trimethyl trimellitate, tri-(2-ethylhexyl) trimellitate, tri-(n-octyl,n-decyl) trimellitate, tri-(heptyl,nonyl) trimellitate, n-octyl trimellitate, bis(2-ethylhexyl)adipate, dimethyl adipate, monomethyl adipate, dioctyl adipate, dibutyl sebacate, dibutyl maleate, diisobutyl maleate, various benzoate esters, various vegetable oils and modified vegetable oils (such as epoxidized vegetable oils, various sulfonamides such as n-ethyl toluene sulfonamide, n-(2-hydroxypropyl) benzene sulfonamide, N-(n-butyl)benzene sulfonamide (DOA)and the like, various phosphate esters such as tricresyl phosphate and tributyl phosphate, glycol esters such as triethylene glycol dihexanoate and tetraethylene glycol diheptanoate and the like, polybutene polymers, various acetylated monoglycerides, alkyl citrates such as triethyl citrate, acetyl triethyl citrate, tributyl citrate, trioctyl citrate, acetyl trioctyl citrate, acetyl trihexyl citrate, butyryl trihexyl citrate and the like; alkyl sulphonic acid phenyl ester, 1,2-cyclohexane dicarboxylate diesters such as 1,2-cyclohexane diisononyl ester, and the like.

Isocyanate components may include one or more plasticizers at a percent by weight (wt %) in an amount ranging from 5 wt % to 40 wt %, 10 wt % to 40 wt %, or 10 wt % to 35 wt %.

Isocyanate components may include at least one surfactant, which may be the same or different from, the one or more isocyanate-reactive component surfactant. Examples of foam stabilizing surfactants include nonionic surfactants and wetting agents such as those prepared by the sequential addition of propylene oxide and then ethylene oxide to propylene glycol, solid or liquid organosilicones, and polyethylene glycol ethers of long chain alcohols. Ionic surfactants such as tertiary amine or alkanolamine salts of long chain alkyl acid sulfate esters, alkyl sulfonic esters and alkyl arylsulfonic acids can also be used. The surfactants prepared by the sequential addition of propylene oxide and then ethylene oxide to propylene glycol are preferred, as are the solid or liquid organosilicones. Examples of useful organosilicone surfactants include commercially available polysiloxane/polyether copolymers such as TEGOSTAB® B8935, B8871, and B8934 by EVONIK®, DABCO™ DC-198 available from Air Products, and NIAX™ L2171 surfactant from Momentive Performance Materials.

Isocyanate components may include one or more surfactants at a percent by weight (wt %) in an amount ranging from 0.1 wt % to 4 wt %, 0.2 wt % to 4 wt %, or 0.2 wt % to 2 wt %.

### B.) Isocyanate-Reactive Component

The isocyanate-reactive component (or B-side) may contain of one or more of copolymer polyols, polyether polyols, tertiary amine catalysts, high molecular weight polyetheramines crosslinkers, cell openers, blowing agents, and other additives.

Isocyanate-reactive components may include one or more copolymer polyols (or modified polyols) include products obtained by graft polymerization of one or more vinyl monomers (e.g., styrene, acrylonitrile), as a mixture with polymeric polyols (e.g., polyether polyols). Copolymer polyols may also include graft polymerization products generated by the reaction of a polyisocyanate and an amino- or hydroxy-functional compound (e.g., triethanolamine) as a mixture with a polymeric polyol.

Isocyanate-reactive components may include one or more copolymer polyols at a percent by weight (wt %) in an amount ranging from 15 wt % to 60 wt %, 20 wt % to 60 wt %, or 20 wt % to 50 wt %. Copolymer polyols may include dispersions of 40% or more of polymer in an aqueous solvent, such as 5% to 50%. Particle sizes of the dispersed copolymer polyols may be less than 50 microns. Copolymer polyols may have a hydroxyl value as determined by ASTM D4274-21 ranging from 10 mg KOH/g to 50 mg KOH/g. In some embodiments, copolymer polyols may include a grafted polyether polyol containing at least 40 wt % copolymerized styrene and acrylonitrile solids and have a hydroxyl value of 20 mg KOH/g or more.

Isocyanate-reactive components may include one or more polyether polyols, such as reaction products of alkylene oxides (e.g., ethylene oxide and/or propylene oxide) with one or more polyol initiators.

Polyol initiators may have a functionality of from 2 to 8, or 3 to 8, and an average hydroxyl number as determined by ASTM D4274-21 in a range of 100 mg KOH/g to 850 mg KOH/g, or 200 mg KOH/g to 650 mg KOH/g

The polyol or polyols may have a viscosity at 25 °C of at least about 500 cP, as measured according to ASTM D455. In some embodiments, a higher viscosity, of at least about 2,000 cP, may be preferable. Preferably, the polyol or polyols have an average molecular weight of from 100 to 10,000, more preferably of from 200 to 5,000.

Suitable initiators for the present invention include: polyols, for example ethylene glycol, diethylene glycol, propylene glycol, dipropylene glycol, butane diol, glycerol, trimethylolpropane, triethanolamine, pentaerythritol, sorbitol and sucrose; polyamines, for example ethylene diamine, tolylene diamine, diaminodiphenylmethane and polymethylene polyphenylene polyamines; and aminoalcohols, for example ethanolamine and diethanolamine; and mixtures of such initiators. Other suitable polyols include polyesters obtained by the condensation of appropriate proportions of glycols and higher functionality polyols with polycarboxylic acids. Still further suitable polyols include hydroxyl terminated polythioethers, polyamides, polyesteramides, polycarbonates, polyacetals, polyolefins and polysiloxanes. Still further suitable isocyanate-reactive components include ethylene glycol, diethylene glycol, propylene glycol, dipropylene glycol, butane diol, glycerol, trimethylolpropane, ethylene diamine, ethanolamine, diethanolamine, triethanolamine and the other initiators mentioned before. Mixtures of such isocyanate-reactive components may be used as well. Most preferably polyols are used which do not comprise primary, secondary or tertiary nitrogen atoms.

Isocyanate-reactive components may include one or more polyether polyols at a percent by weight (wt %) in an amount ranging from 10 wt % to 65 wt %, 10 wt % to 60 wt %, or 15 wt % to 60 wt %.

Isocyanate-reactive components may include one or more tertiary amine catalysts that function to increase the reaction between a polyol and an isocyanate. Suitable tertiary amine catalysts may include the N-alkylmorpholines, N-alkylalkanolamines, aminoalcohols, N,N-dialkylcyclohexylamines, alkylamines where the alkyl groups are methyl, ethyl, propyl, butyl and isomeric forms thereof, and heterocyclic amines. Examples of tertiary amine catalysts include trimethylamine, triethylamine, dimethylethanolamine, N-methylmorpholine, N-ethylmorpholine, N,N-dimethyl-benzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl) ether, morpholine,4,4′-(oxydi-2,1-ethanediyl)bis, triethylenediamine, pentamethyl diethylene triamine, dimethyl cyclohexyl amine, N-acetyl N,N-dimethyl amine, N-coco-morpholine, N,N-dimethyl aminomethyl N-methyl ethanol amine, N, N, N′-trimethyl-N′-hydroxyethyl bis(aninoethyl) ether, N,N-bis(3-dimethyl-aminopropyl) N-isopropanolamine, (N,N-dimethyl)amino-ethoxy ethanol, N, N, N′, N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis(propylamine), (dimethyl(aminoethoxyethyl))((dimethyl amine)ethyl)ether, tris(dimethylamino propyl)amine, dicyclohexyl methyl amine, bis(N,N-dimethyl-3-aminopropyl)amine, 1,2-ethylene piperidine and methyl-hydroxyethyl piperazine.

Isocyanate-reactive components may include one or more tertiary amine catalysts at a percent by weight (wt %) in an amount ranging from 0.5 wt % to 15 wt %, 1 wt % to 15 wt %, or 1 wt % to 10 wt %.

Isocyanate-reactive components may include one or more polyetheramine crosslinkers, particularly polyetheramines having a number average molecular weight greater than 1 kDa, or in the range of 1 kDa to 6 kDa. Polyetheramines may include monoamines, diamines, and higher order amines (e.g., triamines, tetramines, etc.) having an amine functionality of two or more, such as in the range of 2 to 4.

Suitable polyetheramines include resins made from an appropriate initiator to which lower alkylene oxides, such as ethylene oxide, propylene oxide, butylene oxide or mixtures thereof are added, with the resulting hydroxyl-terminated polyol then being aminated. When two or more oxides are used, they may be present as random mixtures or as blocks of one or the other polyether. In the amination step, the terminal hydroxyl groups in the polyol may be primary or secondary hydroxyl groups. Reductive amination processes are known and described in U.S. Pat. No. 3,654,370. Polyetheramines may include commercially available amines such as primary aliphatic JEFFAMINE™ series of polyether amines available from Huntsman Corporation; including T-403, T-3000, T-5000, D-400, D-4000, and the like; or available from BASF including Baxxodur™ EC 3003, and Baxxodur™ EC 311.

Isocyanate-reactive components may include one or more high molecular weight crosslinkers at a percent by weight (wt %) in an amount ranging from 0.5 wt % to 15 wt %, 1 wt % to 15 wt %, or 1 wt % to 10 wt %.

Isocyanate-reactive components may include one or more cell openers that function to stabilize foam formation and reduce phase separation. Cell openers include polethylene/poyoxypropylene (EO/PO) copolymers having an EO content of at least 60 wt %, or at least 75 wt %, and a hydroxyl functionality of at least 4, or at least 6. EO/PO copolymers may have a number average molecular weight of at least 1.5 kDa, such as in a range of 1.5 kDa to 5 kDa.

Cell openers can also include a contact product prepared from at least one organic polyacid (e.g., di-acid, tri-acid, etc.), and at least one of tetraalkylguanidine and a tertiary amine catalyst containing an isocyanate reactive group, such as that described in U.S. Pat. Nos. 9,765,009 and 10,023,681. In some cases, cell openers include silicone-free stabilizers including ORTEGOL™ 500, 501, and the like, from EVONIK™.

Isocyanate-reactive components may include one or more cell openers at a percent by weight (wt %) in an amount ranging from 5 wt % to 40 wt %, 10 wt % to 40 wt %, or 10 wt % to 35 wt %.

Polyurethane foam-forming compositions may include one or more blowing agents, including water and aqueous fluids; chemical blowing agents, such as hydrocarbons, acids, volatile organics, and the like; and physical blowing agents including gases such as nitrogen, air, carbon dioxide, and the like. Blowing agents may be added to the foam-forming composition during mixing at a percent by weight (wt %) ranging from 1 wt % to 15 wt %, or 5 wt % to 15 wt %. Blowing agents may be added to the isocyanate component and/or the isocyanate-reactive component in amount sufficient to provide the mixture with the corresponding weight percentages above.

The isocyanate component and/or the isocyanate-reactive component may have one or more functional additives, as may be useful in the particular manufacturing process that is used or to impart desired characteristics to the resulting foam. These include, for example, catalysts, chain extenders, odor modifiers, fillers, colorants, fire retardants, pigments, antistatic agents, reinforcing fibers, antioxidants, preservatives, acid scavengers, and the like.

Water-resistant polyurethane foams disclosed herein may be prepared by mixing the isocyanate and isocyanate-reactive components in the presence of the catalyst and blowing agent, dispensing the resulting mixture (e.g., into the cavity of a vehicle member or a thermal insulating panel) and allowing the reaction mixture to form a foam. In cavity-filling applications, the foam is dispensed into the cavity and the foam is allowed to expand to occupy available space. The cavity is preferably open, by which it is meant that the portion of the substrate into which the reaction mixture is dispensed is open to the atmosphere as the foam reacts, expands and cures.

As used herein, “cavity” refers to a hollow space within the part, or other suitable shape. The cavity may be one that is incapable of retaining a fluid due to its shape or orientation. Examples of cavity-containing vehicle members include pillars, rockers, sills, sails, cowls, plenum, seams, frame rails, vehicle subassemblies, hydro-formed parts, cross car beams and engine cradles. These may be assembled onto a vehicle or vehicle frame when the foam formulation is applied and foamed.

Examples of thermal insulating panels include the interior and/or exterior walls of a building, or a section of such a wall; the walls of an appliance such as a freezer, refrigerator, cooler, oven, thermos or other insulated decanter and the like.

The ratios of the isocyanate and isocyanates-reactive components are selected so as to provide an isocyanate index (ratio of NCO to isocyanate-reactive groups) of 0.7 to 1.5, or 0.85 to 1.35, or 0.85 to 1.25. The isocyanate and isocyanates-reactive components may be formulated in a volume ratio of from 5:1 to 1:5, 4:1 to 1:4, 2:1 to 1:2, or 1.5:1 to 1:1.5.

The components may be at ambient temperature or at a slightly elevated temperature (from 30 to 80 °C, for example) at the time they are mixed together and dispensed. It is usually unnecessary to apply heat to the vehicle member or thermal insulation panel to drive the expansion and curing reactions, but it is within the scope of the invention to do so. Upon expansion and curing, the foam formulation produces a foam that has a density of from 1.25 to 5 pounds/cubic foot (20 to 80 kg/m³), which at least partially fills the cavity. It should expand to fill the entire cross-sectional area of the cavity, for at least a portion of its length. In some applications, such as vehicle cavity sealing and building wall insulations, the resulting foam acts as a barrier to the infiltration of water and other fluids through the cavity, and also dampens noise and vibration through the filled structure.

The mixture of isocyanate component and isocyanate-reactive component may be cured at a temperature from 0 °C to 60 °C, 10 °C to 50 °C, 15 °C to 45 °C, or 18 °C to 35 °C (e.g., RT). Curing may be indicated by increase in the viscosity after mixing isocyanate component and isocyanate-reactive component, with the eventual formation of a cured foam with a measurable hardness. The cured foam composition may have a range of hardness as determined by ASTM D-2240-15 in a range of 40 to 90 Shore 00, 50 to 85 Shore 00, or 60 to 80 Shore 00.

Water-resistant polyurethane foams disclosed herein may have a water absorption of less than 15% after exposure to 100% relative humidity for 10 days. In some cases, cured foams may have a density according to ASTM D1622-20 of 20 g/cm³ to 80 g/cm³.

The following examples are provided to illustrate the invention, but are not intended to limit the scope thereof. All parts and percentages are by weight unless otherwise indicated.

### Examples

The following examples are presented to further illustrate embodiments of the present invention in detail but are not to be construed as limiting the scope of the claims. Unless otherwise indicated, all parts and percentages are by weight.

In the following example, polyurethane formulations were reacted to form foams, which were then characterized by three criterion: a water absorption target of 8% or less; foam stability with no shrinkage after 15 minutes of dispensing; and stability of the isocyanate-reactive component after 24 hours at 60 °C as indicated by a lack of phase separation. Table 1 lists the materials used in the following examples:

TABLE 1
Components used in the Example formulations

| | | |
|---|---|---|
| Component | Description | Supplier |

Isocyanate-reactive Component

| | | | |
|---|---|---|---|
| Co-polyol | Specflex NC 701 | Grafted polyether polyol containing 40 | Dow |
| | | wt % copolymerized styrene and | Chemical |
| | | acrylonitrile solids and an OHv of 22 mg | Company |
| | | KOH/g. | |
| Polyether | Voranol 4701 | 4,000 Da polyol, high EO content, | Dow |
| polyol | | containing at least 40% solid | Chemical |
| | | | Company |
| Catalyst | SPI 847 | Bis(2-diethylamino ethyl) ether, tertiary | Specialty |
| | | amine catalyst | Product |
| | | | International |
| High MW | Jeffamine D4000 | High molecular weight cross linker. | Huntsman |
| Crosslinker- | | Amine functionalized polypropylene | |
| 1 | | oxide diamine, ~4000 g/mol | |
| High MW | Jeffamine T5000 | HMW amine cross-linker | Huntsman |
| Crosslinker- | | | |
| 2 | | | |
| Polyol | Voranol 800 | HMW polyol-cross-linker | Dow |
| Crosslinker | | | Chemical |
| | | | Company |
| Low MW | Jeffamine D400 | Low MW amine cross-linker | Huntsman |
| Crosslinker- | | | |
| 1 | | | |
| Chain Ext-1 | Glycerine | Chain extender | — |
| Chain Ext-2 | Triethanolamine | Chain extender | — |
| Blowing | Water | — | — |
| Agent | | | |
| Cell Opener- | Ortegol 501 | Cell opener and emulsifier | Evonik |
| 1 | | | |
| Cell Opener- | Voranol 4053 | A polyoxyethylene/polyoxypropylene | Dow |
| 2 | | polyol, hydroxyl functionality 6.9, EO | Chemical |
| | | content of 75 wt %, molecular weight | Company |
| | | 1795 g/mole | |
| Odor | 10125WS | Odor masking additive | Odor control |
| Modifier | | | company |

Isocyanate Component

| | | | |
|---|---|---|---|
| Isocyanate | Papi 20 | Polymeric MDI (74 wt %) | Dow |
| | | | Chemical |
| | | | Company |
| Plasticizer-1 | Vestinol 9 DINP | Branched plasticizer phthalate (12.5 | Evonik |
| | | wt %) | |
| Plasticizer-2 | Jayflex L9P or | 9-10-11 Linear Phthalate (12.5 wt %) | Exxonmobil |
| | Platinol 911P | | or BASF |
| Surfactant-1 | DC-198 | Silicone surfactant (0.35 wt %) | Dow |
| | | | Chemical |
| | | | Company |
| Surfactant-2 | Tegostab B 8870 | Co-surfactant (0.65 wt %) | Evonik |

Sample formulations were prepared by combining the ingredients for the isocyanate component and the isocyanate-reactive component in an agitator for 15 minutes. The isocyanate-reactive component was prepared by combining all ingredients without regard for order, with the exception that water was added at the final step. The isocyanate component was blended together similarly in an agitator for 15 minutes under nitrogen atmosphere. Both components were then added to an AP-10 cannon dispenser machine.

Both materials were loaded to AP-10 Cannon (Italy) dispenser at a ratio of 2:1 Isocyanate component:Isocyanate-reactive component at 46 °C and 750 psi.

Water adsorption is determined by filling a 100 mm×300 mm box constructed from e-coated metal panels with 100 to 150 g of a foam formulation. The foam was allowed to cure for 24 hours at room temperature and the weight was recorded. The cured foam assembly is then exposed to 100% RH at 38 °C for 10 days, followed by a conditioning period of 50% RH at 23 °C for 24 hours. The weight of the “wet foam” is then recorded. Water absorption is calculated by the change in weight according to the formula: (Foam weight wet-Foam weight dry)/Foam weight dry)×100.

The phase stability of the isocyanate-reactive components was tested by adding all ingredients and agitating for an hour. The sample was then placed at 50 °C for 72 hours, followed by visual inspection for phase separation.

Polyurethane foam stability is defined as the production of a foam exhibiting no shrinkage after 15 minute of mixing.

TABLE 2
Sample formulations and results

| Component | CE1 | CE2 | CE3 | CE4 | CE5 | CE6 | IE1 |
|---|---|---|---|---|---|---|---|
| Co-polyol | 34.50 | 34.50 | 34.50 | 34.50 | 34.50 | 34.50 | 33.00 |
| Polyether Polyol | 48.00 | 48.00 | 48.00 | 48.00 | 48.00 | 48.00 | 46.50 |
| Odor Modifier | 0.05 | 0.05 | 0.05 | 0.05 | 0.05 | 0.05 | 0.05 |
| Blowing Agent | 9.00 | 9.00 | 9.00 | 9.00 | 9.00 | 9.00 | 9.00 |
| Catalyst | 3.45 | 3.45 | 3.45 | 3.45 | 3.45 | 3.45 | 3.45 |
| Polyol Crosslinker | — | — | — | 5.00 | — | — | — |
| High MW Crosslinker-1 | — | — | — | — | — | 5.00 | 5.00 |
| Low MW Crosslinker-1 | 5.00 | — | — | — | — | — | — |
| Low MW Crosslinker-2 | — | — | 5.00 | — | — | — | — |
| Chain Ext-1 | — | 5.00 | — | — | — | — | — |
| Chain Ext-2 | — | — | — | — | 5.00 | — | — |
| Cell Opener-1 | — | — | — | — | — | — | 3.00 |
| Total | 100 | 100 | 100 | 100 | 100 | 100 | 100 |
| Isocyanate-reactive | | | | | | | |
| Component | | | | | | | |
| Isocyanate | NCO/Polyol = 2:1 mix ratio (by Volume) | | | | | | |
| Water absorption | >15% | >15% | >15% | >15% | >15% | <1% | <1% |
| Phase Separation | No | No | No | No | No | No | No |
| Foam Stability | Yes | Yes | Yes | Yes | Yes | No | Yes |

TABLE 3
Sample formulations and results

| Component | CE7 | CE8 | CE9 | IE2 |
|---|---|---|---|---|
| Co-polyol | 34.5 | 33.00 | 33.00 | 33.00 |
| Polyether polyol | 48 | 46.50 | 46.50 | 46.50 |
| Catalyst | 3.45 | 3.45 | 3.45 | 3.45 |
| Odor modifier | 0.05 | 0.05 | 0.05 | 0.05 |
| Water | 9 | 9 | 9 | 9 |
| Polyol Crosslinker | — | 5 | — | — |
| High MW Crosslinker-1 | 5 | — | 5 | — |
| High MW Crosslinker-2 | — | — | — | 5 |
| Cell Opener-1 | — | 3 | — | 3 |
| Cell Opener-2 | — | — | 3 | — |
| Total Isocyanate-reactive | 100 | 100 | 100 | 100 |
| Component | | | | |
| Isocyanate | NCO/Polyol = 2:1 mix ratio (by Volume) | | | |
| Water absorption | <1% | <20% | <1% | <1% |
| Phase Separation | No | No | Yes | No |
| Foam Stability | No | Yes | Yes | Yes |

As shown, comparative samples CE1-5 used low molecular weight crosslinker (polyamine or polyol), the foam is stable and no phase separation, but water absorption was significantly higher than the targeted specification of less than 15 wt %. For CE6 and CE7, formulations containing high molecular weight crosslinker only exhibited minimal phase separation in the isocyanate-reactive component and minimal water absorption, but the sample failed to produce a stable foam. For CE8, a combination of low molecular weight crosslinker and a cell opener Ortegol 501 produced a stable PU foam with poor water resistance, although no phase separation occurred in the isocyanate-reactive component. For CE9, a combination of high molecular weight crosslinker and a high EO-content cell opener (Voranol 4053) produced a stable PU foam with excellent water resistance was obtained, but the isocyanate-component was instable and phase separation occurred.

In contrast, the inventive examples demonstrate that a combination of high molecular weight crosslinker with a cell opener generates a PU foam with low water absorption and foam stability. IE1 formulated with cell opener provided a very stable foam, no phase separation, and excellent water absorption performance. For IE2, a high molecular weight crosslinker combined with cell opener Ortegol 501, producing a very stable foam, no phase separation in the isocyanate-reactive component, and excellent water absorption performance. While not limited by theory, it is believed that use of the high molecular weight polyetheramines crosslinker at a concentration of above 3 wt % interacting with the cell opener strengthens the foam, preventing water penetration into the cell structure.

What is claimed is:

1. A water-resistant polyurethane foam composition, comprising the reaction product of:
an isocyanate component comprising, at a percent by weight (wt %):
a polymeric MDI blend at 65 wt % to 85 wt %,
a plasticizer at 10 wt % to 35 wt %, and
a cell opener at 0.2 wt % to 2 wt %; and
an isocyanate-reactive component comprising, at a wt %:
a copolymer polyol at 20 wt % to 50 wt %,
a polyether polyol having a functionality of 3 to 8 at 15 wt % to 60 wt %,
a tertiary amine catalyst at 1 wt % to 10 wt %,
a polyetheramine crosslinker having a number average molecular weight of 1 kDa or more at 1 wt % to 10 wt %,
a foam stabilizer at 1 wt % to 8 wt %, and
a blowing agent at 5 wt % to 15 wt %.

2. The composition of claim 1, wherein the foam has a water absorption of less than 15% after exposure to 100% relative humidity for 10 days.

3. The composition of claim 1, wherein the cell opener is a high EO content polyol.

4. The composition of claim 1, wherein the cell opener is a contact product prepared from at least one organic polyacid and at least one of tetraalkylguanidine and a tertiary amine catalyst containing an isocyanate reactive group.

5. The composition of claim 1, wherein the isocyanate component and isocyanate-reactive component are combined at a volume ratio of 2:1.

6. The composition of claim 1, wherein the isocyanate-reactive component comprises a copolymer polyol containing at least 40% solids.

7. The composition of claim 1, wherein the polymeric MDI blend has an NCO content of 18% to 25%.

8. The composition of claim 1, wherein the foam has a density according to ASTM D1622-20 of 20 g/cm³ to 80 g/cm³.

9. An automotive component including the foam composition of claim 1.

10. A method comprising:
inserting the solid, thermally expandable polyolefin composition of claim 1 into a cavity, and
performing a heat-expansion step by heating the thermally expandable polyolefin composition in the cavity to a temperature sufficient to expand the polyolefin composition to form a foam that fills at least a portion of the cavity.

11. The method of claim 7, wherein the cavity is contained in a part, assembly or sub-assembly of an automotive vehicle.
